(19) United States
(12) Patent Application Publication
(10) Pub. No.: US 2014/0369788 A1
(43) Pub. Date: Dec. 18, 2014

(54) RIVET STRUCTURE FOR CONNECTING STRUCTURE

(71) Applicants: FIH (Hong Kong) Limited, Kowloon (HK); SHENZHEN FUTAIHONG PRECISION INDUSTRY CO., LTD., Shenzhen (CN)

(72) Inventors: CHIH-WEI CHANG, New Taipei (TW); GUANG-FEI CAO, Shenzhen (CN); HONG-TAO LIU, Shenzhen (CN)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 14/068,907

(22) Filed: Oct. 31, 2013

(30) Foreign Application Priority Data
Jun. 17, 2013 (CN) 2013203446231

(51) Int. Cl. F16B 19/00; F16B 19/04

(52) U.S. Cl. CPC F16B 19/008; F16B 19/04
USPC 411/501

(57) ABSTRACT

A connecting structure includes a first metal plate, a second metal plate, a rivet, and two sealing members. The first metal plate defines a through hole, and the second metal plate defines an engaging hole aligned with the through hole. The rivet includes a head portion, a rivet body, and a latching end integrally formed together. An annular slot is defined between the rivet body and the latching end. The rivet body and the latching end have a larger diameter than the through hole. The head portion and the rivet body are received in the engaging hole, and the latching end extrudes an inner wall of the through hole to form an annular latching projection received in the annular slot. The two sealing members seal the through hole and the engaging hole.

### BACKGROUND

1. Technical Field

The present disclosure relates to a rivet structure for a connecting structure.

2. Description of related art

Many portable electronic devices, such as mobile phones, laptops, and personal digital assistants (PDAs), incorporate at least two housings. The housings need to be fixed together by a rivet. When the housings are made of different metal materials, the surfaces of the two housings need to be treated to prevent corrosion between the two surfaces. However, installing the rivets destroys some portions of the two housings, which allows air, water, or other debris from entering a clearance space among the housings and the rivet, thereby causing corrosion.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles. Moreover, in the drawings like reference numerals designate corresponding parts throughout the several views.

FIG. 1 shows a schematic view of an exemplary embodiment of a connecting structure including a rivet.

FIG. 2 is an enlarged view of the rivet.

FIG. 3 shows an assembled view of the connecting structure using the rivet.

FIG. 4 shows a cross-sectional view taken along line IV-IV of FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

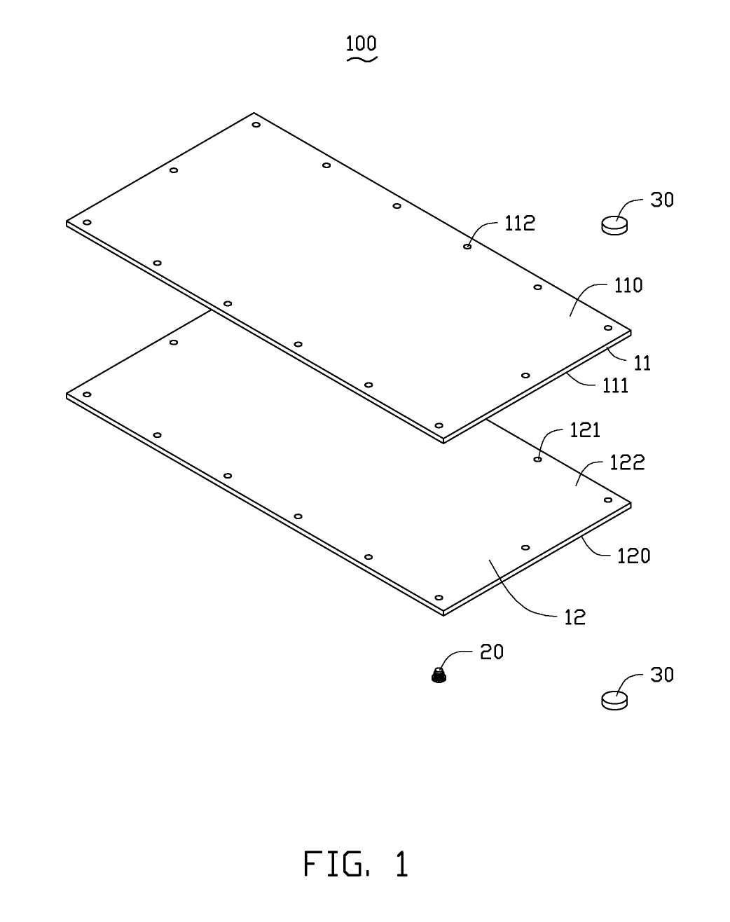

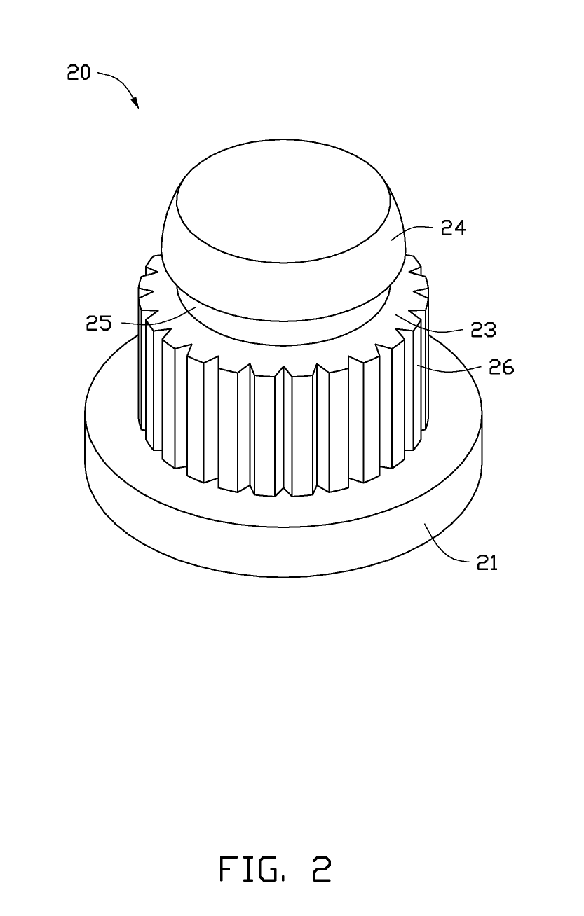

FIGS. 1 and 2 illustrate a connecting structure 100 including a first metal plate 11, a second metal plate 12, at least one rivet 20, and at least one pair of sealing members 30. In this exemplary embodiment, the first metal plate 11 and the second metal plate 12 are each made of different materials. For example, the first metal plate 11 is made of aluminum or aluminum alloy, and the second metal plate 12 is made of stainless steel. The first metal plate 11 includes a first surface 110 and a second surface 111 opposite to the first surface 110. The first metal plate 11 defines at least one through hole 112. The second metal plate 12 includes a first surface 120 and a second surface 122. At least one engaging hole 121 is defined in the second metal plate 12. The engaging hole 121 is a stepped hole and includes an outer hole 1210 and an inner hole 1211. A diameter of the outer hole 1210 is larger than a diameter of the inner hole 1211, and the outer hole 1210 communicates with the inner hole 1211. The outer hole 1210 is defined adjacent to the first surface 120, and the inner hole 1211 is defined adjacent to the second surface 122.

Referring to FIG. 2, the rivet 20 is made of metal having a higher hardness than the first metal plate 11. The rivet 20 includes a head portion 21, a rivet body 23, and a latching end 24 integrally formed together. The head portion 21 is received in the outer hole 1210 and has a larger diameter than the rivet body 23 and the latching end 24. The rivet body 23 is substantially cylindrical and has a larger diameter than the latching end 24. A diameter of the rivet body 23 is substantially the same as the diameter of the inner hole 1211. An annular slot 25 is defined between the rivet body 23 and the latching end 24. A diameter of the latching end 24 is slightly larger than that of the through hole 112. A plurality of parallel grooves 26 is defined around a circumference of the rivet body 23.

The sealing members 30 are used for filling and sealing the through hole 112 and the engaging hole 121. The sealing members 30 prevent water, dust, and other debris from entering a clearance space among the rivet 20, the first metal plate 11, and the second metal plate 12.

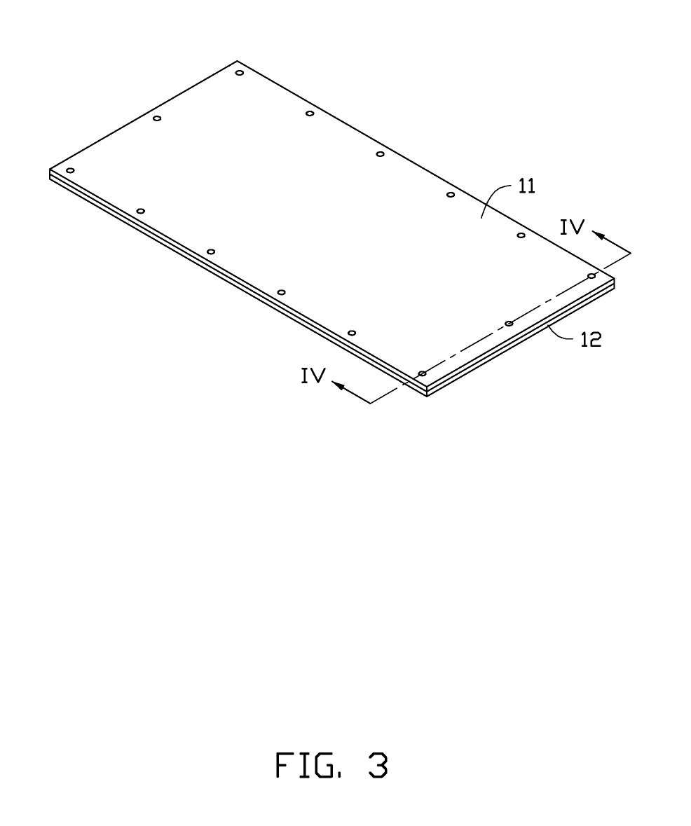

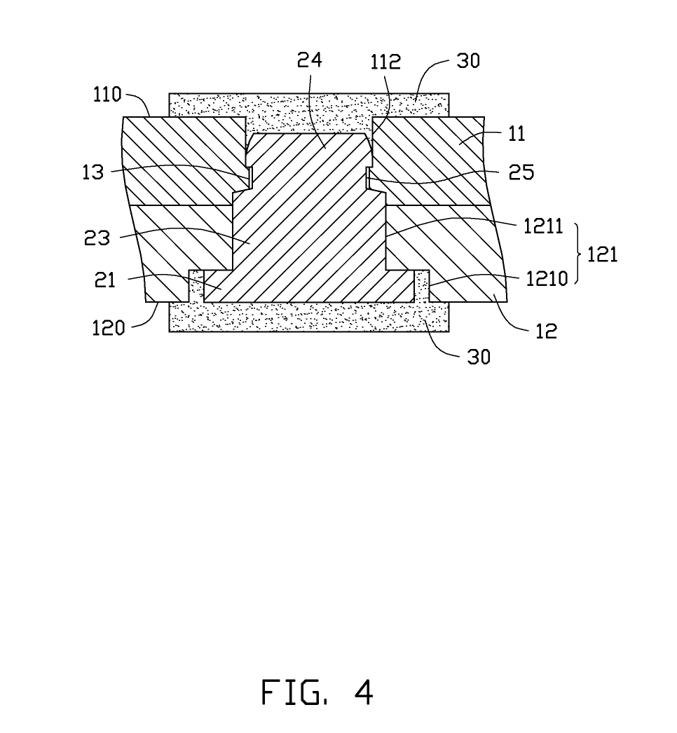

Referring to FIGS. 3 and 4, in assembly, the first metal plate 11 is positioned on the second metal plate 12, such that the through hole 112 is aligned with the engaging hole 121. In one embodiment, the rivet 20 is received in the engaging hole 121 by hand, such that a distal end of the latching end 24 is partly received in the through hole 112. Then, the head portion 21 of the rivet 20 is pressed by a pressing block of a rivet machine (not shown) until the latching end 24 is completely received in the through hole 112. Since the diameter of the latching end 24 is larger than that of the through hole 112, the latching end 24 extrudes parts of an inner wall of the through hole 112 as the latching end 24 is forcibly received in the through hole 112. As the latching end 24 is forced into the through hole 112, the rivet body 23 also extrudes a part of the inner wall of the through hole 112. Parts of the inner wall of the through hole 112 extruded by the latching end 24 enter into the annular slot 25 to form an annular latching projection 13. Parts of the inner wall extruded by the rivet body 23 enter into the grooves 26. Thus, the rivet 20 is latched in the through hole 112 and the engaging hole 121.

After the first metal plate 11 and the second metal plate 12 are connected together by the rivet 20, the sealing members 30 are filled in the through hole 112 and the engaging hole 121.

In one embodiment, the sealing members 30 are formed by an injection molding process. Firstly, an injection mold is provided. The assembled first metal plate 11 and second metal plate 12 with the rivet 20 is placed in a die chamber of the injection mold. During the injection molding process, molten plastic flows into the through hole 112 and the engaging hole 121 to form the sealing members 30. The sealing members 30 cool and harden to be tightly bonded with the first metal plate 11, the second metal plate 12, and the rivet 20.

In another embodiment, the sealing members 30 are formed by a low-pressure perfusion molding process. The assembled first metal plate 11 and second metal plate 12 with the rivet 20 is placed in a mold cavity of a perfusion mold. Thermosetting liquid epoxy resin is fed into the mold cavity. A vacuum apparatus removes air from the mold cavity to prevent air contaminants from mixing in the epoxy resin. The liquid epoxy resin flows into the through hole 112 and the engaging hole 121 to form the sealing members 30.

In the connecting structure 100, the sealing members 30 prevent water, dust, and other debris from entering the clearance space among the rivet 20, the first metal plate 11, and the second metal plate 12. Therefore, the first metal plate 11 and the second metal plate 12 are prevented from easily corroding.

It should be also understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A connecting structure comprising:
a first housing defining a through hole;
a second housing defining an engaging hole aligned with the through hole; and
a rivet including a head portion, a rivet body, and a latching end integrally formed together, an annular slot defined between the rivet body and the latching end, the rivet body and the latching end having a larger diameter than the through hole;
two sealing members;
wherein the head portion and the rivet body are received in the engaging hole, the rivet body and the latching end extrude an inner wall of the through hole to form an annular latching projection received in the annular slot, and the two sealing members seal opposite ends of the rivet.

2. The connecting structure as claimed in claim 1, wherein the rivet is made of metal having a higher hardness than the first metal plate.

3. The connecting structure as claimed in claim 2, wherein the head portion has a larger diameter than the rivet body and the latching end, the rivet body is substantially cylindrical, and has a larger diameter than the latching end.

4. The connecting structure as claimed in claim 3, wherein the rivet body defines a plurality of parallel grooves.

5. An electronic device comprising:
a first housing defining a through hole;
a second housing defining an engaging hole aligned with the through hole; and
a rivet including a head portion, a rivet body, and a latching end integrally formed together, an annular slot defined between the rivet body and the latching end;
two sealing members;
wherein the head portion and the rivet body are received in the engaging hole, the rivet body and the latching end extrude an inner wall of the through hole to form an annular latching projection received in the annular slot, and the two sealing members seal opposite ends of the rivet.

6. The electronic device as claimed in claim 5, wherein the head portion has a larger diameter than the rivet body and the latching end, the rivet body is substantially cylindrical, and has a larger diameter than the latching end.

7. The electronic device as claimed in claim 6, wherein the rivet body defines a plurality of parallel grooves.
